(19) United States
(12) Patent Application Publication
(10) Pub. No.: US 2009/0196969 A1
(43) Pub. Date: Aug. 6, 2009

(54) System and Method for Processing and Packaging of Fresh Fruit in a Controlled Environment Chamber

(75) Inventor: Miguel Guzman, Aptos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Fresh Express, Inc., Salinas, CA (US)

(21) Appl. No.: 12/027,230

(22) Filed: Feb. 6, 2008

(51) Int. Cl. A23L 1/212; A47J 43/00

(52) U.S. Cl. 426/419; 99/467

(57) ABSTRACT

The present invention provides an apparatus and a method for fresh fruit processing that minimizes the exposure of the fruit to microbial contamination. The apparatus includes: a controlled environment chamber having an inlet portion configured to receive whole fruit and an outlet portion configured to deliver processed fresh fruit; a floor that is sloped downward from the inlet portion toward the outlet portion; an access portal on a lateral side of the controlled environment chamber, which is configured to provide access from the outside of the controlled environment chamber to the inside of the controlled environment chamber through a sealable barrier; an outlet portion having a container inlet that is configured to receive a container into the interior of the controlled environment chamber and a container outlet that is configured to deliver a container filled with processed fresh fruit out of the controlled environment chamber.

### BACKGROUND OF THE INVENTION

The present invention relates to systems and methods for the processing and packaging of fresh fruit in a controlled environment chamber. In particular, the present invention provides a temperature and microbial content controlled work space, while preserving visual and tactile access to the fruit being processed.

The shelf life of fresh cut fruit is influenced by the initial microbial content and the storage temperature of the fruit. A low initial microbial count on the surface of the processed fresh fruit in conjunction with the suitable storage temperature will result in a longer shelf life of the fresh cut fruit. However, once the fresh cut fruit becomes contaminated with microorganisms, the microorganism count tends to grow exponentially under favorable temperature conditions. For instance, fresh cut cantaloupe is extremely susceptible to microbial spoilage due to its lack of acidity and richness in sugars and other nutrients. Under abusive storage conditions, which are typically defined as where the temperature exceeds 40° F., the fresh cut cantaloupe develops detrimental spoilage characteristics such as off-flavors and off-odors within days, rendering the fruit unacceptable to a consumer.

Microbial contamination exists naturally on the whole fruit surface that is brought into a plant for the processing. However, fruit contamination can also be increased during the in-plant processing because of the microbes transferred from the fruit processing tools and operators onto the fruit. The incoming, natural microbial contamination is typically reduced by subjecting the raw fruit to water, water steam, and disinfectant showers. One or more of these contamination reduction steps may be used, depending on the type of fruit, contamination level, type of available equipment, and established practices. From this point in the process, the fresh fruit is typically peeled, cut, and deseeded, which may introduce new sources of microbial contamination from the processing tools or the operators, which, in turn, leads to the accelerated fruit spoilage. Minimization of the microbial contamination during fresh fruit processing leads to extended shelf life for the fruit.

The need for the microbial isolation of the in-process fruit and vegetable has been recognized in the food processing industry. Some existing devices and methods attempt to provide a physical barrier between the operator and in-process vegetables, especially onions, such that the fumes released by the cut vegetable are isolated from the operator's eyes and nose, but those devices provide no microbial reduction on the surface of the processed fruit or vegetable. Other devices and methods are based on the enclosures which kill microbes at high temperatures just prior to packaging the fruit or vegetable into sterilized containers, but they do not allow for the hand access to the interior of the enclosure. Some other devices and methods reduce the microbial counts by submitting vegetable or fruit, or their seeds, to a liquid or gas sanitizer showers, but no hand or mechanized cutting or other processing occurs. Some enclosures use a liquefied inert gas to maintain sanitized conditions of the chamber interior, which is very expensive.

Thus, there exists a need for devices and methods for fresh fruit processing which will minimize microbial contamination of the fresh cut fruit during the in-plant processing of the fruit in a practical and cost effective way. The reduced microbial contamination results in longer shelf life and more consistent quality of the fresh cut fruit.

### BRIEF SUMMARY OF THE INVENTION

The present invention provides an apparatus and a method for fresh fruit processing that minimizes the exposure of the fruit to microbial contamination, while providing visual and tactile access to the fruit, and also enabling easy removal of the processing byproducts through waste discharge portals. The inlet and outlet portions of the apparatus can be sealable, and can be configured for receiving containers with the fresh fruit and for the removal of the processed fruit containers, but without directly touching the contents of the container. Similarly, the unwanted fruit processing byproducts can be removed through a sealable discharge trap without directly touching the byproducts. The tactile access to the interior of the sealed chamber is provided through the access portals on the chamber, which can be outfitted with soft, sealed sleeves. For instance, pairs of latex gloves attached around the access portals in an airtight manner can be used as the sealed sleeves. Visual access is provided by panels of transparent material, like glass or acrylic panels, which are sealed against the chamber. The work space may use a temperature control unit for maintaining pressure, temperature, and purity of the air inside the chamber.

In one embodiment, the apparatus for processing fresh fruit includes: a controlled environment chamber having an inlet portion configured to receive whole fruit and an outlet portion configured to deliver processed fresh fruit; a floor that is sloped downward from the inlet portion toward the outlet portion; an access portal on a lateral side of the controlled environment chamber, which is configured to provide access from the outside of the controlled environment chamber to the inside of the controlled environment chamber through a sealable barrier; an outlet portion comprising a container inlet that is configured to receive a container into the interior of the controlled environment chamber and a container outlet that is configured to deliver a container filled with processed fresh fruit out of the controlled environment chamber.

In one aspect, the access portal is one of a plurality of access portals, each access portal being disposed on a lateral side of the controlled environment chamber.

In another aspect, the controlled environment chamber is sealable against the outside environment.

In yet another aspect, the controlled environment chamber is a sterilized chamber.

In another embodiment, a method for processing of fresh fruit includes: delivering fresh fruit to an inlet portion of a controlled environment chamber, the controlled environment chamber being sealable against the outside environment, the controlled environment chamber having a floor, the floor being sloped downward from the inlet portion toward an outlet portion of the controlled environment chamber; processing the fresh fruit on the floor of the controlled environment chamber without directly touching the fresh fruit through an access portal disposed on a lateral side of the controlled environment chamber, the access portal being configured to provide access from the outside of the controlled environment chamber to the inside of the controlled environment chamber through a sealable barrier; receiving via a container inlet of the controlled environment chamber a container without directly touching the container into the controlled environment chamber; and packing the container with processed fresh fruit pieces without directly touching the fresh fruit pieces through an access portal disposed on a lateral side of the controlled environment chamber, where processing is conducted within the controlled environment chamber, while maintaining the interior of the controlled environment chamber at a higher pressure than the outside environment.

For a further understanding of the nature and advantages of the invention, reference should be made to the following description taken in conjunction with the accompanying figures. It is to be expressly understood, however, that each of the figures is provided for the purpose of illustration and description only and is not intended as a definition of the limits of the embodiments of the present invention.

### BRIEF DESCRIPTION OF THE DRAWINGS

FIG. 1 illustrates a top plan view of the controlled environment chamber, in accordance with one embodiment of the present invention.

FIG. 2 is a perspective view of the controlled environment chamber, corresponding to the system of FIG. 1.

FIG. 3 is a side view of the controlled environment chamber, corresponding to the system of FIG. 1.

FIG. 3A shows a cross-sectional view; and FIG. 3B shows a partial side view for the chamber.

FIG. 4 is an interior view of the controlled environment chamber, corresponding to the system of FIG. 1.

The following drawing description is common to FIGS. 5-8, and is followed by a brief description that is specific to each of the FIGS. 5-8. FIGS. 5-8 show fruit quality measurement results for two test cases: the standard environment and the controlled environment chamber in accordance with one embodiment of the present invention. Time on the abscise is measured in number of days elapsed since the fruit was processed. The ordinates on FIGS. 5 and 6 are in the logarithmic scale. The ordinates on FIGS. 7 and 8 are shown on a sensory, i.e. subjective scale.

FIG. 5 shows comparative bacteria count on the fruit surface as a function of time.

FIG. 6 shows comparative yeast count on the fruit surface as a function of time.

FIG. 7 shows comparative appearance scores of the fruit on a sensory scale as a function of time.

FIG. 8 shows comparative customer acceptability scores of the fruit on a sensory scale as a function of time.

### DETAILED DESCRIPTION OF THE INVENTION

The embodiments of the present invention are directed toward systems and methods for the processing and packaging of fresh fruit in a controlled environment chamber. The advantages of the controlled environment chamber for fresh fruit processing and packaging are numerous. For example, the chamber isolates the in-process fruit from the microbial contamination coming from the operators and the tools. Although typical in-plant fruit processing procedures strive to implement high levels of cleanness of the operator's clothes and the tools, a certain level of microbial contamination at the fruit surface still occurs, leading to a gradual decay of the fresh fruit. Irrespective of the post-processing temperature conditions of the cut fresh fruit (i.e. below 35° F. considered favorable and above 35° F. considered unfavorable) the initial microbial contamination will still influence the overall microbial count at a future time.

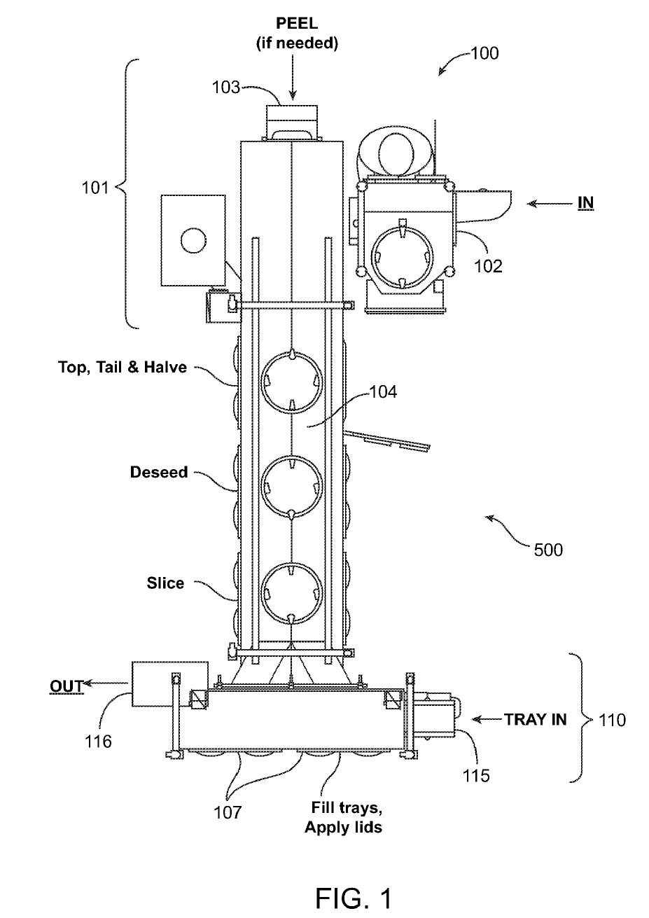

The details of an exemplary embodiment of the present invention are explained with reference to FIGS. 1-4. The exemplary embodiment is described with reference to fresh cantaloupe processing, but it will be clear to a person skilled in the art that the described system and method can be used to process other fresh fruits.

FIG. 1 shows a top plan view of system 100 for processing fruit in a controlled environment chamber in accordance with one embodiment of the present invention. Controlled environment chamber 104 has an inlet portion 101 for receiving the whole fresh fruit. The fresh fruit can be received into system 100 through inlet port 102. The whole fresh fruit typically arrives to inlet port 102 in the containers suitable for transporting the whole fruit around the processing floor. Depending on the type and size of the fresh fruit, and on the availability of fruit peelers on the processing floor, the peeling of the fresh fruit can be done outside of the controlled environment chamber 104, in which case the peeled fresh fruit is presented at inlet port 102 of the chamber, or, in the alternative, the whole fresh fruit can be received into system 100 through an optional inlet port 103. Optional inlet port 103 is typically used for the melon products where the pre-process peeling in an auto peeler was not done, thus making the incoming fruit too large for inlet port 102. The incoming fresh fruit surface can be pasteurized prior to the delivery to inlet ports 102 or 103, but the surface pasteurization can also be done using nozzles that are internal to the chamber, as explained in detail below. The inlet portion 101 can be sealable against the outside environment to prevent microbial contamination of the controlled environment chamber.

The fresh fruit which was received at inlet portion 101, either through inlet port 102 or inlet port 103, is moved into the interior of controlled environment chamber 104 for the processing, like, for instance, top and tail removal, halving, deseeding, slicing, etc. The fresh fruit is moved from one processing step to another along the chamber interior, while the waste is removed from the chamber using a method explained in detail below. The processing is done by the operators who are on the outside of controlled environment chamber 104, but who also have a visual and tactile access to the interior of the chamber, as explained below.

As the fresh fruit processing is finished, and the processed fresh fruit product is ready to be taken out of controlled environment chamber 104, the processed fruit is moved to outlet portion 110, which has tray inlet 115 and tray outlet 116. Empty trays are received at tray inlet 115, the processed fruit is loaded on the trays, and the trays are taken out through tray outlet 116. It will be clear to a person skilled in the art that the tray inlet and outlet can be arranged in many different configurations, including having multiple tray inlets and outlets, as well as sharing the same opening for both the inlet and outlet functions. Tray inlet 115 and tray outlet 116 can be sealable against the outside environment to prevent microbial contamination of the controlled environment chamber. The trays can take many different forms depending on the type and volume of the fruit processed. The trays function as a temporary storage medium for the processed fresh fruit, and they need not necessarily be rigid, but can be plastic bags, wiremesh, or similar.

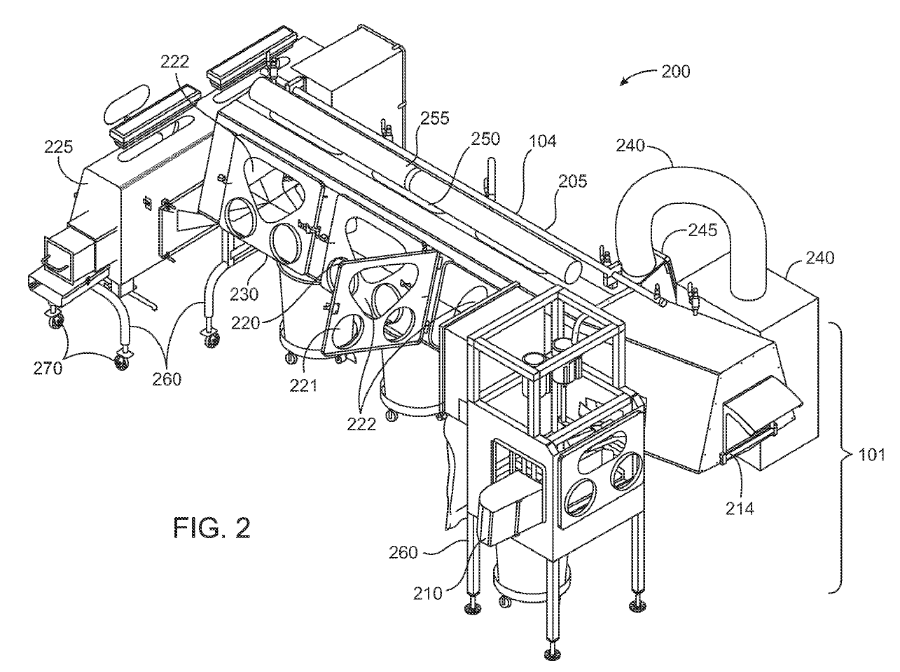

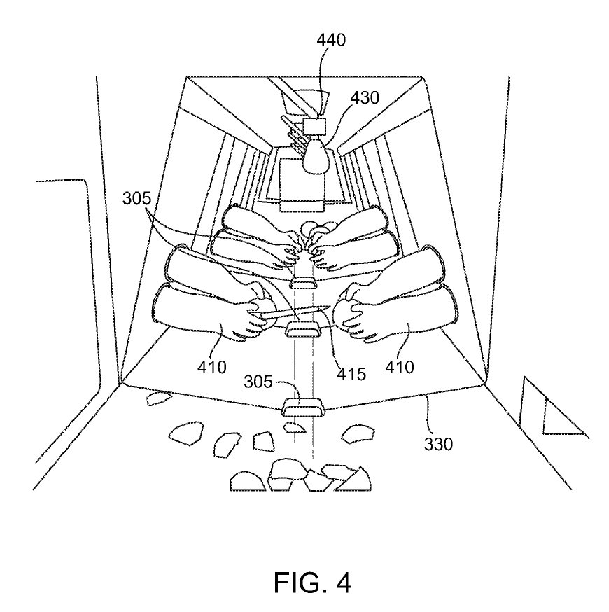

FIG. 2 shows a perspective view of the controlled environment chamber for fresh fruit processing in accordance with one embodiment of the present invention. Controlled environment chamber 104 has inlet portion 101 for the incoming fresh fruit. The operation of inlet portion 101 is described in detail above. Controlled environment chamber 104 has a plurality of access portals 220 on its lateral walls, which provide the operators with tactile and visual access into the interior of the controlled environment chamber. The access portals 220 can be sealable. Typically, pairs of rubber or latex or similar gloves 410 (shown on FIG. 4) are sealably attached on access portals 220 to provide tactile access to the fresh fruit. Gloves 410 form a barrier between the interior of controlled environment chamber 104 and the outside environment. In order to provide visual access to the interior of controlled environment chamber 104, transparent panels 222 made of acrylic or glass or similar transparent material are provided for the access portals 220. Doors 221 can be hingedly mounted on access portals 220 and can be opened to allow cleaning and sterilization of controlled environment chamber 104. When doors 221 are provided, then gloves 410 and transparent panels 222 can be mounted directly on the doors. When in their closed position, doors 221 can be sealed against the frame of the controlled environment chamber 104. One or more additional doors 107 (shown on FIG. 1) are positioned on outlet portion 115 for the visual and tactile access to the shipping trays and the processed fresh fruit.

Controlled environment chamber 104 can be outfitted with an air handling unit 240 which filters the air, therefore reducing microbial and dust contamination inside the chamber. Air filter 245 can be performing to HEPA standards. Air handling unit 240 can be configured to maintain the required air temperature and moisture settings. Thus, the control of the air filtration, temperature, and moisture level is now localized to within the interior of the chamber, which is a much easier control task than the air conditioning of the entire fruit processing floor. The air handling unit can be programmed to maintain positive pressure inside controlled environment chamber 104, which will minimize microbial and dust intake from the outside of the chamber, since the positive pressure inside the chamber will reduce seepage of the dust and microbes into the chamber interior. Furthermore, the operators standing or sitting on the outside of controlled environment chamber 104 do not have to suffer at uncomfortably low temperatures which are maintained inside controlled environment chamber 104, as, for instance, below 35° F. for a preferred fresh fruit environment inside the chamber.

Controlled environment chamber 104 can have one or more top windows 250. The windows provide better visibility inside the chamber. A light source 255 can be positioned above windows 250 to further improve visibility inside the chamber.

Controlled environment chamber 104 can have legs 260 upon which the chamber is mounted and elevated to the height appropriate for the operators' comfort. The legs can have casters 270 for the of chamber repositioning on the processing floor. The casters 270 can be lockable for the stability of the chamber and the safety of the operators.

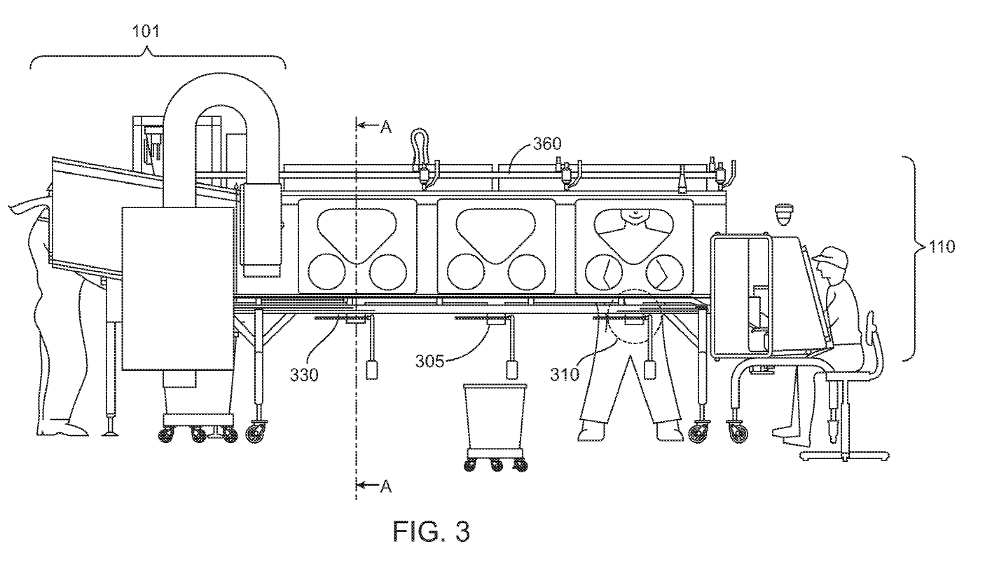

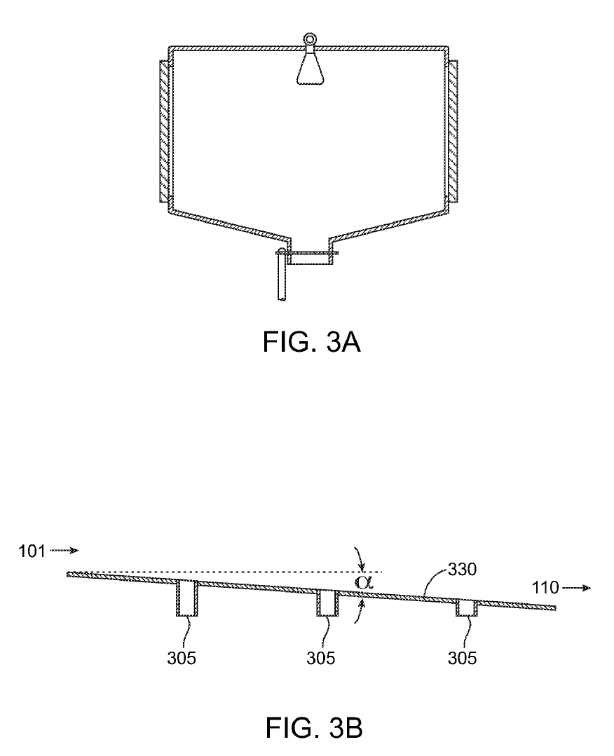

FIGS. 3, 3A, and 3B show a side view, a cross sectional view, and a floor detail view respectively of controlled environment chamber 104 according to one embodiment of the invention. Controlled environment chamber 104 has a floor 330 that slopes downwards from inlet 101 towards outlet 110, and also from the lateral sides of the controlled environment chamber 104 towards the middle of the chamber. Therefore, sloped floor 330 of the controlled environment chamber 104 can have approximately a V-shaped cross-section, and is inclined from inlet 101 to outlet 110, as shown in cross-section A-A on FIG. 3A and detail B on FIG. 3B. The side-to-side and inlet-to-outlet slope of floor 330 are emphasized in FIGS. 3A and 3B to better explain the purpose of the slope. It should be noted that the slopes do not have to be as steep as shown in FIGS. 3A and 3B. The slope on floor 330 helps the movement of the in-process fresh fruit from inlet portion 101 to outlet portion 110 of controlled environment chamber 104 over different fresh fruit processing stations. Additionally, the fresh fruit processing waste material is collected in the middle of the side-to-side, V-shaped floor slope for easy removal through one or more discharge traps 305. As is the case with all other access points on controlled environment system 104, the waste material discharge traps 305 can be made sealable.

The cross-sectional view A-A on FIG. 3A shows the location of the discharge traps 305 along the sloped floor 330 of controlled environment chamber 104. Discharge traps 305 can be conveniently operated via a knee activation mechanism 310. Waste baskets may be positioned directly beneath the discharge ports, and can have caster wheels for easy transporting of the process waste.

Controlled environment chamber 104 has a manifold 360 for fluid distribution to a system of nozzles which are distributed inside the chamber. Manifold 360 delivers a washing or pasteurizing fluid to the nozzles, as described below in connection with FIG. 4.

FIG. 4 shows the interior of controlled environment system 104. The operators access the tools and the in-process fruit by placing their hands in gloves 410. Because gloves 410 can be made of rubber or latex or similar materials, and because the gloves can be sealably attached to the access portals 220 or doors 221, the microbial transfer from the operators' hands onto the fresh in-process fruit is minimized. A similar set of gloves can be positioned close to inlet portion 101 and outlet portion 110 to provide access to the incoming and outgoing fruit without touching the fruit directly by the hand. Operators use cutting tools 415 in connection with the different phases of fresh fruit processing. Cutting tools 415 can be sanitized before placing them inside controlled environment system 104, in order to reduce fresh fruit bacterial contamination. As shown in FIG. 1, different stages of the fresh fruit processing, like, for instance, top and tail removal, halving, deseeding, slicing, etc., can be conveniently arranged along the length of controlled environment chamber 104 interior, such that the operators push the fresh in-process fruit to the next station along the length of the chamber. Sloped floor 330 makes it easier to transfer the fresh fruit to the next processing station. The process waste that is created at different processing stations is removed through knee activated discharge traps 305.

Controlled environment chamber 104 can be equipped with wash manifold 360, which feeds wash fluid to one or more spray nozzles 430. Wash fluid can clean and pasteurize the fruit at different process phases, but it can also be used to clean and sterilize the interior of the chamber and the cutting tools. To achieve these multiple purposes, the nozzles can be selected such that they spray up and down, and also such that they are rotatable. The position and angle of spray nozzles 430 can be adjusted either automatically, through a positioning mechanism 440, or manually. A person skilled in the art of wash nozzles would know how to select the nozzles with the required functions from a wide variety of nozzles available on the market. In case of the manual adjustment, an operator would use gloves 410 to access nozzles 430 in order to set the nozzles at a proper angle for washing the in-process fresh fruit or for the periodic cleaning and sterilizing of the interior of the controlled environment chamber. The processing tools can also be cleaned and sterilized using nozzles 430 in conjunction with appropriate washing fluid. Sealable openings 305 are used to release washing fluid and waste that accumulates at sloped floor 330 of controlled environment chamber 104.

The controlled environment chamber provides many advantages for the processing of fresh cut fruit. For instance, temperature and moisture regulation is localized to a smaller space, the chamber itself, as opposed to the entire processing floor. This saves energy and also provides for improved operators' comfort, because they do not have to suffer at sub 35° F. temperature in order to keep the fruit in the process in the favorable temperature range. Proper workspace lighting and sanitation is also easier due to the localized requirements. If equipped with legs and caster wheels, the chamber can be easily repositioned as the process needs change and new equipment arrangements are needed on the floor.

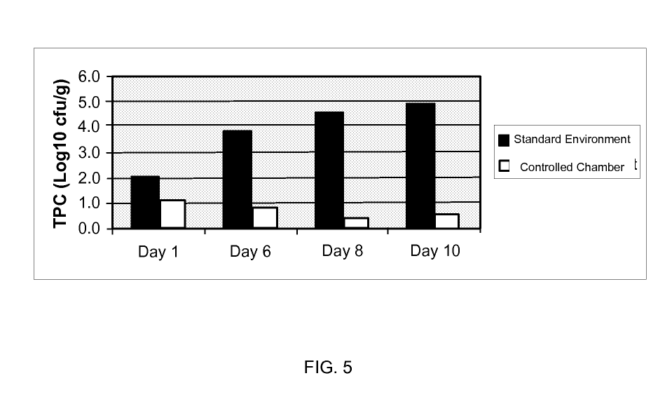

Some advantageous features of the controlled environment chamber as they relate to reduced microbial contamination and increased shelf life of the fresh cut fruit are discussed below and summarized in FIGS. 5-8. FIGS. 5-8 show the results of the experiments where batches of fresh melons were processed in two different environments: the industry standard fruit processing plant and the controlled environment chamber as in this invention. In all the experiments the incoming fruit was first inspected for the consistency in quality and grade, in order to assure that both the standard and the controlled environment chamber method started from the equivalent input material. The fruit for both cases came from the same incoming lot, and it underwent the same disinfection procedure prior to cutting. The tools were sanitized prior to use for both methods. The workers were required to use plastic gloves, hairnets, plastic aprons, plastic sleeves and other protective gear consistent with good manufacturing practices in the fresh cut fruit industry. For the standard environment, all equipment and utensils were sanitized the previous night according to standard sanitation practices. The controlled environment chamber in accordance with the principles of the invention was completely washed internally before fruit processing and packing.

At the end of the processing, fresh cut melon pieces were packaged in the industry standard plastic packages, and shrink banded. Next, the packages produced in both the standard and the controlled environment were transported to an independent research lab for the storage and quantification of the microbial level. The storage temperature was set at 35° F. for the first 24 hours, followed by 45° F. for the next 9 days, for a total duration of 10 days. Industry standard microbiological tests were used in measuring Aerobic Total Plate Count and Yeast and Mold Count. Subjective sensory evaluation of the fruit appearance and acceptability were done on the hedonic scale of 1 to 5, where 1=poor, 2=fair, 3=acceptable, 4=good, and 5=excellent. The evaluations were conducted on the days 1, 6, 8, and 10. For all the graphs in FIGS. 5-8 the solid bars are used for the industry standard environment, and open bars are used for the controlled environment chamber case.

FIG. 5 shows total aerobic microbial plate count on a logarithmic scale as a function of time. It can be seen that the plate counts are consistently and significantly lower for the controlled environment chamber case. For instance, starting from the day 1 the total plate count measured in cfu/g (colony forming unit/granulocyte) is an order of magnitude smaller for the controlled environment compared to the standard environment. This initial lower total microbial plate count of the controlled environment is maintained throughout the duration of the experiment, and by day 10 the difference between the two test cases exceeds four orders of magnitude. In fact, for the controlled chamber case it appears that the count is going down in time for the first eight days of the experiment, but this can be attributed to a typical artifact of the measurements at around the sensitivity threshold of an instrument. Thus, the total aerobic microbial plate count, i.e. microbial levels, are consistently lower for the fresh fruit that was processed in the controlled environment chamber than for the same fruit processed in the industry standard environment.

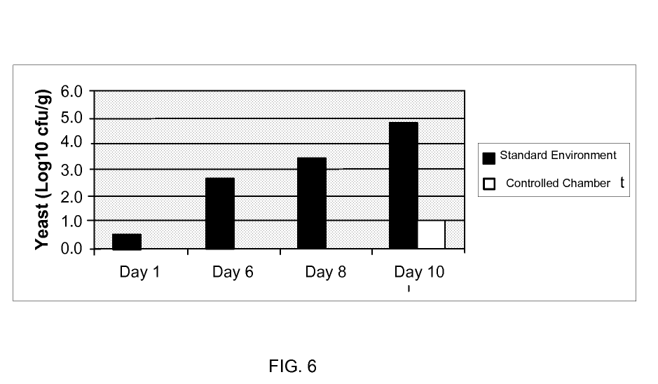

FIG. 6 shows average yeast and mold count on a logarithmic scale as a function of time. Similar to the observations made above with respect to FIG. 5, the yeast and mold count is consistently smaller for the fresh fruit processed in the controlled environment when compared to the industry standard environment. By day 10, the difference exceeds three orders in magnitude. This is due to the lower initial yeast and mold contamination at the time of the fresh fruit processing for the controlled chamber, which causes consistently lower count throughout the experiment, because the yeast and mold colonies multiply exponentially at least in the initial phases of the fruit decay. Thus, processing the fresh fruit in the controlled chamber environment results in persistently lower yeast and mold counts when compared to the standard environment.

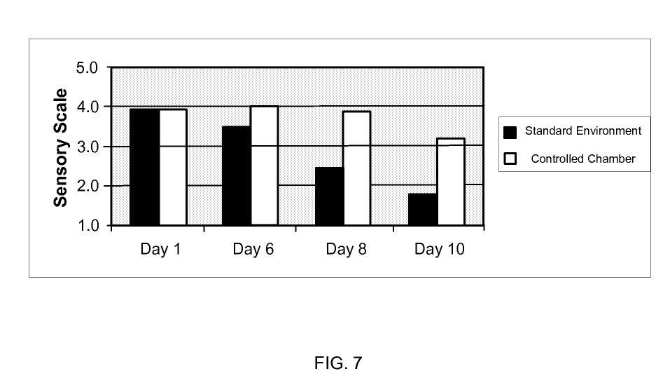

FIG. 7 shows average appearance scores as a function of time for the standard and controlled chamber environments. The appearance scores at day 1 have about the same value for the fresh cut fruit made in either environment. This should be expected because the microbial and yeast growth has not progressed enough to affect the appearance of the fruit. As time progresses, the appearance scores for the fresh cut fruit processed in the standard environment deteriorate faster than for the same fruit processed in the controlled chamber. At day 10, average appearance score for the fruit processed in the standard environment is somewhere between 1 and 2, meaning between “poor” and “fair.” In the case of the fruit processed in the controlled chamber environment, the lower microbial and yeast counts resulted in the fruit having average appearance score above 3, meaning above the “acceptable” value. Thus, the fresh cut fruit processed in the controlled environment, as in one of the embodiments of the present invention, maintains the appearance above “acceptable” score when stored at 45° F. for longer than 8 days, or when stored at an average temperature higher than about 40° F. for 10 days.

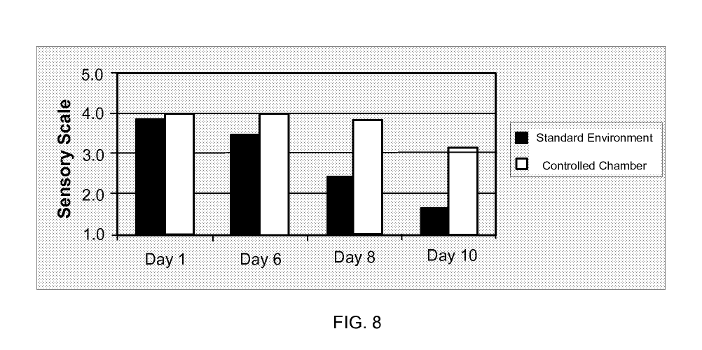

FIG. 8 shows average acceptability scores as a function of time for the standard environment and the controlled chamber environment. As expected and as explained above, the acceptability scores at day 1 have about the same value for the fresh cut fruit made in either environment. Due to the higher microbial and yeast content of the fresh cut fruit coming from the standard environment, their acceptability scores deteriorate faster than those for the fresh cut fruit processed in the controlled chamber environment. At day 10, the fresh cut fruit processed in the standard environment has the average acceptability score somewhere between 1 and 2, meaning between “poor” and “fair.” In the case of the fruit processed in the controlled chamber environment, the lower microbial and yeast counts resulted in the fruit having average acceptability score above 3, meaning above “acceptable.” Thus, the fresh cut fruit processed in the controlled environment, as in one of the embodiments of the present invention, maintains the above “acceptable” acceptability score when stored at 45° F. for longer than 8 days, or when stored at an average temperature higher than about 40° F. for 10 days.

As will be understood by those skilled in the art, the present invention may be embodied in other specific forms without departing from the essential characteristics thereof. These other embodiments are intended to be included within the scope of the present invention, which is set forth in the following claims.

What is claimed is:

1. An apparatus for processing fresh fruit, comprising:
a controlled environment chamber having an inlet portion configured to receive whole fruit, and an outlet portion configured to deliver processed fresh fruit,
said controlled environment chamber having a floor, said floor being sloped downward from said inlet portion toward said outlet portion;
an access portal disposed on a lateral side of said controlled environment chamber, said access portal being configured to provide access from the outside of said controlled environment chamber to the inside of said controlled environment chamber through a sealable barrier;
said outlet portion comprising a container inlet configured to receive a container into the interior of the controlled environment chamber, and a container outlet configured to deliver a container filled with processed fresh fruit out of the controlled environment chamber.

2. The apparatus of claim 1, wherein said access portal is one of a plurality of access portals, each access portal being disposed on a lateral side of said controlled environment chamber.

3. The apparatus of claim 1, wherein said controlled environment chamber is sealable against the outside environment.

4. The apparatus of claim 1, wherein said controlled environment chamber is a sterilized chamber.

5. The apparatus of claim 1, wherein said floor being sloped downward from said inlet portion toward said outlet portion is also sloped downward from the side walls of said controlled environment chamber toward the middle of said floor.

6. The apparatus of claim 1, further comprising a discharge trap disposed in said floor of said controlled environment chamber.

7. The apparatus of claim 5, wherein said trap is operable via a knee-activated member disposed below said floor.

8. The apparatus of claim 5, wherein said discharge trap is one of a plurality of discharge traps.

9. The apparatus of claim 1, wherein said access portal is fitted with a pair of gloves, said gloves forming a barrier between the interior of said controlled environment chamber and the outside environment.

10. The apparatus of claim 1, wherein said access portal comprises a door that is hingedly coupled with said lateral side.

11. The apparatus of claim 10, wherein said door further comprises a window.

12. The apparatus of claim 1, further comprising a wash manifold installed along the length of the controlled environment chamber, said manifold being configured for delivering a wash fluid to a spray nozzle.

13. The apparatus of claim 12, wherein said spray nozzle is one of a plurality of nozzles.

14. The apparatus of claim 12, wherein said spray nozzle is rotatable with respect to an inlet to said nozzle.

15. The apparatus of claim 12, wherein said spray nozzle is configured to spray a wash fluid in an upward and a downward direction.

16. The apparatus of claim 1, further comprising an air handling unit configured to deliver filtered air to said controlled environment chamber.

17. The apparatus of claim 16, wherein said air handling unit is configured to maintain a positive pressure within said controlled environment chamber with respect to the outside environment.

18. The apparatus of claim 16, further comprising an air cooler configured to chill the air being delivered by the air handling unit.

19. The apparatus of claim 1, further comprising a top window located at the top of said controlled environment chamber.

20. The apparatus of claim 19, further comprising a light source configured to deliver light into said controlled environment chamber through said top window.

21. The apparatus of claim 1, further comprising legs upon which the controlled environment chamber is mounted.

22. The apparatus of claim 21, further comprising lockable casters mounted on said legs.

23. A method for processing of fresh fruit, comprising:
delivering fresh fruit to an inlet portion of a controlled environment chamber, the controlled environment chamber being sealable against the outside environment, the controlled environment chamber having a floor, the floor being sloped downward from the inlet portion toward an outlet portion of the controlled environment chamber;
processing the fresh fruit on the floor of the controlled environment chamber without directly touching the fresh fruit through an access portal disposed on a lateral side of the controlled environment chamber, the access portal being configured to provide access from the outside of the controlled environment chamber to the inside of the controlled environment chamber through a sealable barrier;
receiving via a container inlet of the controlled environment chamber a container without directly touching the container into the controlled environment chamber; and
packing the container with processed fresh fruit pieces without directly touching the fresh fruit pieces through an access portal disposed on a lateral side of the controlled environment chamber,
wherein said processing is conducted within the controlled environment chamber, while maintaining the interior of the controlled environment chamber at a higher pressure than the outside environment.

24. The method of claim 23, wherein said fresh fruit comprises a melon.

25. The method of claim 24, wherein said processing comprises peeling, deseeding and slicing the melons.

26. The method of claim 23, further comprising discharging waste product through a discharge trap disposed in the floor of the controlled environment chamber.

27. The method of claim 26, comprising operating the discharge trap by activating a knee-activated member disposed below the floor of the of the controlled environment chamber.

28. The method of claim 23, wherein said delivering comprises delivering surface pasteurized fresh fruit.

29. The method of claim 23, wherein said processing the fresh fruit without directly touching the fresh fruit comprises processing the fresh fruit using a pair of gloves fitted with the access portal, the gloves forming a barrier between the interior of the controlled environment chamber and the outside environment.

30. The method of claim 24, wherein said processing is characterized by processed melons having an aerobic total plate count measure that is lower than melons processed on the outside of the controlled environment chamber.

31. The method of claim 24, wherein said processing is characterized by processed melons having a yeast and mold measure that is lower than melons processed on the outside of the controlled environment chamber.

32. The method of claim 24, wherein said processing is characterized by processed melons having microbial levels that are lower than melons processed on the outside of the controlled environment chamber.

33. The method of claim 24, wherein said processing is characterized by processed melons having a shelf life of at least eight days when stored at a temperature of about 45 F.

34. The method of claim 24, wherein said processing is characterized by processed melons having a shelf life of at least ten days when stored at a temperature of about 40 F.

35. The method of claim 23, wherein the controlled environment chamber is a sterilized chamber.

36. The method of claim 23, further comprising washing the interior of the controlled environment chamber before or after said delivering, said processing, said receiving, and said packing; said washing being performed by using a wash manifold installed along the length of the controlled environment chamber, the manifold being configured to deliver a wash fluid to a spray nozzle.

37. The method of claim 36, wherein the spray nozzle is one of a plurality of nozzles.

38. The method of claim 36, wherein the spray nozzle is rotatable with respect to an inlet to the nozzle.

39. The method of claim 36, wherein the spray nozzle is configured to spray a wash fluid in an upward and a downward direction.

40. The method of claim 23, further comprising using an air handling unit configured to deliver filtered air to the controlled environment chamber.

41. The method of claim 40, wherein the air handling unit is configured to maintain a positive pressure within the controlled environment chamber with respect to the outside environment.

42. The method of claim 40, wherein the air handling unit further comprises an air cooler configured for chilling the air being delivered by the air handling unit.
